(19) United States
(12) Patent Application Publication
(10) Pub. No.: US 2003/0035868 A1
(43) Pub. Date: Feb. 20, 2003

(54) Method for producing food product packages with modified environment packaging

(75) Inventors: Curtis L. Coulter, Springdale, AR (US); Mike Throgmorton, West Fork, AR (US)

Correspondence Address: HEAD, JOHNSON & KACHIGIAN, 228 W. 17TH PL., TULSA, OK, 74119, US

(73) Assignee: Packaging Specialties, Inc.

(21) Appl. No.: 10/217,062

(22) Filed: Aug. 12, 2002

Related U.S. Application Data
(60) Provisional application No. 60/312,954, filed on Aug. 15, 2001.

(51) Int. Cl. A23B 4/00

(52) U.S. Cl. 426/125

(57) ABSTRACT

There is disclosed a method for producing food product packages which produces packaging having the desirable characteristics of the conventional overwrap food tray with printed film and excellent storage and display characteristics achieved with modified environment packaging. The fresh food products suitable to be packaged by the method include fresh meat, particularly ground beef, fruits, and vegetables, particularly mushrooms. The method has an advantage of using generally conventional tray wrapping apparatus and generally conventional trays and involves the use of a flexible plastic wrap material preprinted and also perforated with microperforations of predetermined size and density to be permeable to air while inhibiting any flow of liquids from the package. This plastic wrap material is wrapped around trays by a tray wrapping machine so perforation patterns provide microperforation openings on top of the trays and on sides of the trays, 4 to 16 of which are then placed in an outer container from which the air is exhausted and replaced with a non-oxidizing gas. The tray container is sealed to complete the process.

### CROSS-REFERENCE TO RELATED APPLICATIONS

This application claims priority to U.S. provisional patent application serial No. 60/312,954, filed on Aug. 15, 2001.

### STATEMENT REGARDING FEDERALLY SPONSORED RESEARCH OR DEVELOPMENT

Not applicable.

### BACKGROUND OF THE INVENTION

There has been a longstanding problem in the packaging of fresh fruit, vegetables, and meat, particularly ground beef, for which numerous solutions have been proposed over the years. The problem arises because fresh meat, for example, needs to be maintained in an environment substantially free of oxygen while being shipped and stored prior to its being offered to the customer in display cases in supermarkets and elsewhere. A substantially complete absence of oxygen, however, causes fresh meat to have an undesirable purplish-red coloration that is unattractive to consumers. In order for the fresh meat to bloom again to its bright red color which is desirable to the purchasers, it must be exposed to the natural oxygen containing air environment of the supermarket just prior to being placed in display cases for customer viewing and access. An early method for solving this problem is disclosed in U.S. Pat. No. 3,681,092 to Titchenal, et al., issued Aug. 1, 1972. As disclosed in that patent, the fresh meat may be inserted in an oxygen permeable plastic film package which is then placed into a substantially oxygen impermeable outer container. Oxygen is removed from both the packages and the containers are sealed. After the container and packages are shipped to the retail store, the outer container is removed and the product is ready to be displayed. The present invention is an improvement on this old process and other more-recent approaches to most efficiently provide long, safe storage times for food products in an outer oxygen impermeable container while providing trays or other packages within the container that will attractively display the food product.

Previous attempts to achieve similar results include that disclosed in U.S. Pat. No. 5,711,978 to Breen, et al., issued Jan. 27, 1998. Breen, et al., disclosed the method of forming fresh meat packaging to produce an outer barrier bag having a plurality of packing trays therein, each tray overwrapped with a web of clear plastic wrapping material. In the process, the overwrap tray is ventilated by forming slits in the perimeter of the overwrapped portions of the wrapping material. While this produces the generally desired result, the step of forming slits in the overwrap tray to ensure gas communication between enclosed regions of the overwrap tray and the outside ambience atmosphere is inefficient and does not effectively seal liquids such as meat juices. Also the tray is required to have openings around the rim for gas communication from the tray interior to the exterior. These are disadvantages overcome by the present invention.

Another earlier approach to controlled atmosphere packaging is shown in U.S. Pat. No. 4,055,672 to Hirsch, et al., issued Oct. 25, 1977. Hirsch, et al., disclose use of a package wall which includes a composite of an inner gas permeable layer and an outer gas impermeable layer. The packages formed by heat sealing the inner layer of the composite to the flanges of a tray while leaving the outer layer of the composite readily peelable from the inner layer. The Hirsch, et al., method requires non-standard heat sealing techniques and does not take advantage of the well-developed food tray overwrapping techniques as does applicant's method according to the invention.

An earlier method disclosed in U.S. Pat. No. 3,681,092 to Titchenel, et al., does not produce the conventional form of overwrapped food trays but instead commences by placing the meat in a pack formed of oxygen permeable film with one or more evacuation ports. The process continues with removing air from the packs and also the multi-pack container in which they are placed, sealing the container and then shrinking the film of said internal packs about the meat in the pack. This method does not readily provide an attractive package of the type desired by customers and retailers.

U.S. Pat. No. 3,574,642, to Weinke, issued Apr. 13, 1971 discloses a method for producing a package which is not similar to the customary overwrap tray food package and which requires specialized formation and sealing steps not provided by conventional tray wrapping equipment.

The process according to the invention has an advantage of using generally conventional tray wrapping apparatus and generally conventional trays in a novel way and improves upon modified atmosphere packaging techniques and apparatus that are more complicated, difficult, and expensive to employ. An important feature of the method according to the invention involves the use of a flexible plastic wrap material which has been preprinted in a customary fashion and also is perforated with a pattern of microperforations of predetermined size and density to be permeable to air (and oxygen) while inhibiting any flow of liquids from the package. Flexible plastic wrap material is wrapped around generally conventional trays by a properly configured tray wrapping machine so that the perforation patterns provide the microperforation openings for air or gas permeation on the top of the trays and preferably on sides of the trays. The trays are then placed in an outer container from which the air is exhausted and replaced with a non-oxidizing gas such as carbon dioxide or nitrogen. The sealed container is then ready for shipment and storage. From the foregoing discussion, it will be seen that the present invention provides a method for producing fresh meat, fruits, or vegetables food product packages with modified environment packaging which overcomes disadvantages of prior methods to produce a packaged product having the desirable characteristics of the conventional overwrapped food tray with printed wrapping and the excellent storage and display characteristics that can be achieved with modified atmosphere packaging.

### SUMMARY OF THE INVENTION

The present invention is directed to new and improved methods for producing modified atmosphere packaging wherein multiple food trays of generally conventional appearance and form are packed in a sealed package for storage and shipment and where the overwrapped food trays have inconspicuous microperforation patterns in the overwrap film that causes the ground beef or other food product in the food tray to be exposed to the oxygen of normal atmosphere in display cases thereby causing the product to bloom to the bright color associated with freshness by the purchaser.

Although not so limited, the method according to the invention in the preferred embodiments utilizes conventional product handling and packaging apparatus with relatively little modification including tray loaders, conveyors, tray wrapping and sealing machines and multi-tray package assembling apparatus with air exhaust and atmosphere replacement means.

The packaging materials utilized in the process preferably include conventional food trays used for ground beef or the like and continuous plastic wrap film with predetermined microperforation patterns, preferably shaped in place to fit on the top of the overwrap tray and in some embodiments on one or more sides of the tray wrap. Although it would usually be desirable to utilize automated apparatus in carrying out the method of the invention so that labor costs can be minimized, the practicality of the method is not limited to the use of fully automated equipment for performing method steps.

As previously stated, according to the method a wrap film supply of continuous microperforated shrink wrap or stretch wrap film is provided for overwrapping the trays. Usually, but not necessarily, the wrap film will be printed with a repeating graphics identifying the product, product trademarks, and other required labeling text. Commonly used and readily available tray wrapping machines have the capability of locating the wrap film panels relative to the trays so that trademarks, logos, identification, and required text are properly located in a predetermined manner on the finished overwrap trays. This is usually accomplished by optical sensors of the tray wrapping machines which respond to printed eye-marks which are inconspicuously printed on the wrap film panels to facilitate registration of the printing on the trays.

The perforated wrap film provided to the tray wrapping machines preferably has the perforation patterns registered with those same printed eye-marks associated with the print patterns thereby requiring little or no modification to the tray wrapping machines to assure that the placement of the perforation patterns on the respective trays is accurate and uniform just as the placement of the print pattern.

Prior to reaching the tray wrapping machines, the generally conventional trays (for meat or other food products) are filled with product at a conventional product filling station before proceeding to the tray wrapping station. At the tray wrapping station, the tray wrapping machine separates a segment of the wrap film as necessary, said segment having a complete printed pattern, and a complete microperforations pattern. In some cases, the wrap film segments may be mostly transparent and labeling desired may be applied over or under the wrap film in a separate step; the only different consideration in that case is that the additional labeling material should not seriously obstruct the microperforation pattern of the wrap film segments. As previously indicated, each of the product trays is overwrapped in conventional fashion by the tray wrapping machine causing the microperforations pattern to be properly placed with respect to the tray, usually on the top of the tray and at least one side of the tray. It is preferable that the microperforations are positioned to be absent from corners and other portions of the tray subject to greater stretching in the wrapping process.

In a generally conventional fashion the wrap film on the trays is sealed, usually by heat sealing the bottom portion of the tray, after which the trays are assembled and packed into impermeable plastic tray containers in groups of from 4 to 16 trays. Tray containers may be in the form of bags or cartons or variations thereof After the trays have been placed into an unsealed tray container, the air is at least partially exhausted from the tray container and consequently from the wrapped trays therein due to the permeability provided by the microperforations in the wrap film. A modified atmosphere is then provided to the tray containers composed primarily of inert gas and the tray containers are sealed. Again, the inert gas will permeate the wrapped trays due to the microperforations in the wrap film.

The above processes are repeated to provide containers for the food trays with long period food-preserving modified atmospheres, which containers may be opened to remove the wrap trays to expose them to normal atmosphere at the time and place of display and sale. The microperforation patterns are such that the ambient oxygen containing atmosphere of display cases or the like will rapidly permeate the tray causing the product to obtain the desirable appearance caused by exposure to oxygen. If desired, an oxygen scavenger of known conventional form may be placed in the container with the trays, but this is not an essential feature of the method according to the invention.

An important feature of the method according to the invention is that the wrap film is in a permeable form not requiring post-wrap operations to render the sealed tray permeable to gaseous atmosphere. Furthermore, the wrapping of the trays according to the invention avoids any enlargement or tearing of the microperforations thereby assuring uniformity in and control of permeability of each tray wrapping. It is therefore possible to attain good permeability for the purpose of providing the modified atmosphere in the packaging process without allowing liquids in the packages to escape through enlarged or torn perforations.

In addition to providing the above features and advantages, it is an object of the present invention to provide a method of producing modified environment packaging for food products whereby containers of food trays are produced with a long-period food-preserving modified atmosphere which containers may be opened to remove wrapped trays that will quickly attain the desirable appearance caused by exposure to oxygen in the normal atmosphere to make them ready for customer display.

It is another object of the present invention to provide a method for producing modified environment packaging for a meat product such as ground beef in which a number of overwrap trays, typically 12 or 16 trays of generally conventional appearance are packed in an oxygen impermeable tray container, the wrap film of the trays being rendered permeable by patterns of microperforations positioned in a pre-determined manner on the tray wrap so that the meat product will desirably be exposed to oxygen containing atmosphere after removal from the modified atmosphere of the tray container.

It is still another object of the present invention to provide a method for overwrapping trays of fresh food products with microperforated wrap film to produce overwrap trays having microperforations primarily in the top central portion and side portions of the overwrap tray package.

Other objects and advantages of the present invention will be apparent from consideration of the following description in conjunction with the appended drawings described below.

### BRIEF DESCRIPTION OF SEVERAL VIEWS OF THE DRAWINGS

FIG. 1 is a schematic flow diagram graphically illustrating steps of a preferred embodiment of the process according to the invention;

FIG. 2 illustrates the placement of a microperforation patterned wrap film segment relative to a food tray according to the method of the invention;

FIG. 3 shows in perspective view the manner in which a food tray is wrapped according to the invention;

FIG. 4 is a side elevational view of the food tray shown in FIG. 3;

FIG. 5 shows in perspective view a form of multi-tray package produced by the process; and

FIG. 6 is a side elevational view of the package of FIG. 5 showing the interior thereof

### DETAILED DESCRIPTION OF THE INVENTION

In the following description, the following terms are defined as follows:

“Wrapping Station” refers to a unit in a packaging facility where wrap film is applied to a tray having food products within it. Those skilled in the art will appreciate that there is a wide variety of automated wrapping stations, but that a wrap station may also include one or more persons who wrap trays manually.

“Product Fill Station” refers to a unit in a packaging facility in which food products are placed in trays. There are current a wide variety of automated machines designed to place food products within packaging trays. However, it is also possible for the product filling station to include one or more persons who insert food products into trays manually.

“Microperforations” refer to small holes in wrap film that allow air to permeate the film but preferably small enough to prevent liquids from permeating the film.

“Wrap Film” refers to thin films used to cover food products within trays. Those skilled in the art will appreciate that there are a wide variety of suitable wrap films formed of many various polymers, including polyolefins and polyvinylchlorides. Any wrap film is suitable so long as it is capable of being effectively sealed to a food product tray and is readily susceptible to microperforations.

“Sealing Station” refers to a unit in a packaging facility wherein wrap film was effectively sealed to food product trays. Those skilled in the art will appreciate that there are a variety of sealing methods and automated machinery to accomplish the sealing methods. Some films are sealed while shrinking them by application of heat. Other films are heat sealed, fused, or melted together. Adhesives may also be used. As with other stations in a packaging facility, this station may be either automated or include one or more persons who seal the wrap film manually.

“Inert Gas” refers to any of a number of gases known to those skilled in the art, especially noble gases and nitrogen gas. Those skilled in the art will appreciate that any gas capable of preventing oxidation and/or impede growth of microorganisms is suitable. It may also be desirable to include in the inert gas oxygen scavengers to further prevent oxidation. Those skilled in the art will appreciate that the use of oxygen scavengers may be further enhanced by also adding catalysts. It may also be desirable to apply oxygen scavengers to the tray or film wrap itself.

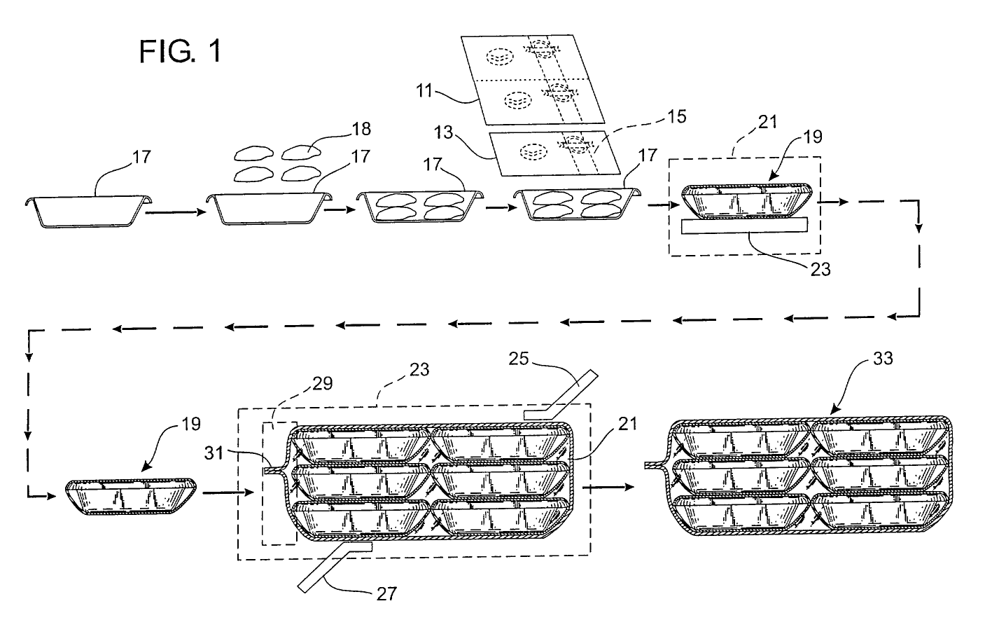

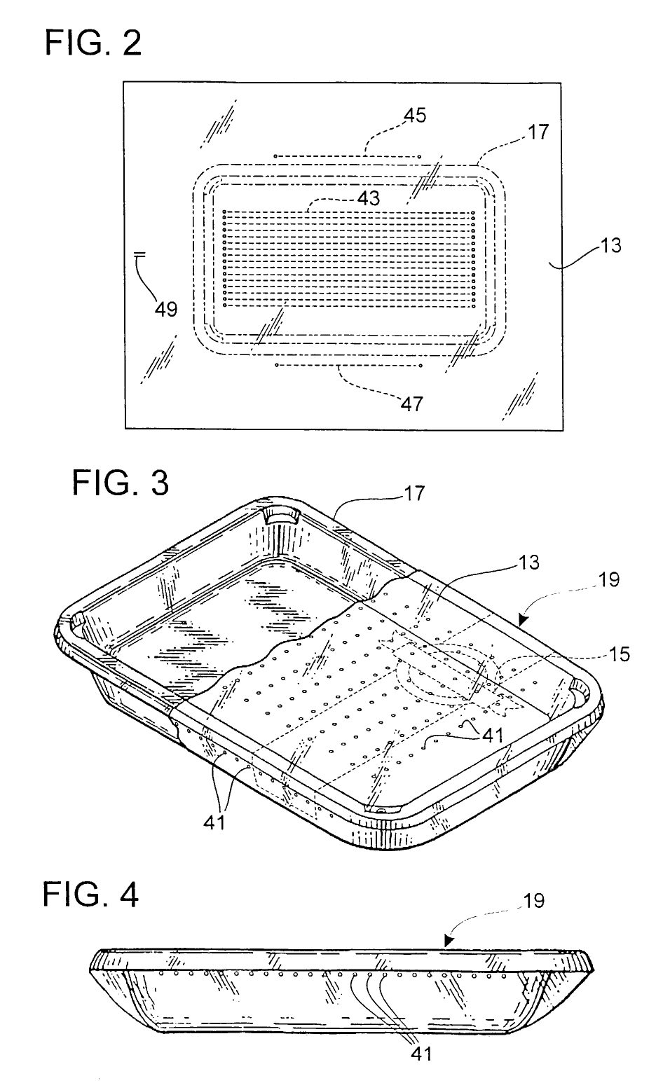

Referring to FIGS. 1 through 6, there is shown in FIG. 1 a schematic flow chart in graphic form illustrating a method of producing modified environment packaging according to the invention. Generally conventional semi-rigid plastic trays 17 as commonly used for packaging food products, for example ground beef, are loaded with food product 18 which may comprise several items or a single item. While the process according to the invention is particularly desirable for packaging ground meat products or other meat products, it may be utilized in any circumstance in which a modified atmosphere for the package product is desirable during storing and shipping. Fresh food and vegetable products, for example mushrooms, will benefit from the present invention in packaging thereof The tray 17 and product contents 18 are overwrapped with segments 13 from a supply of wrap film which is rendered permeable to air and oxygen by one or more patterns of microperforations 43, 45, and 47 as shown in FIG. 2. The wrap film 11 may be of the shrink wrap type or the stretch wrap type both of which are in common use with tray overwrap packaging machines of well-known types as disclosed, for example, in U.S. Pat. No. 5,014,489 to Terminella, et al.

In most cases, the wrap film segment 13 will be imprinted with trademarks, logos, decoration, and/or required product labeling text. In accordance with usual practice in the art, each segment 13 will have an eye-mark 49 imprinted thereon which is sensed and utilized to control the registration of the wrap film segment 13 relative to the tray 17 to ensure proper conformation of the overwrap tray, together with the proper positioning on the tray of any printed matter and, in accordance with the present invention, the proper location of microperforation patterns 43, 45, and 47, all as shown in FIGS. 2, 3, and 4.

Formation of the overwrap tray 19 is completed in a conventional sealing unit 21, usually by heat sealing the overlapping wrap film portions on the bottom of the tray with a heat sealing unit 23.

As shown in FIGS. 3 and 4, controlled permeability of the overwrap tray 19 is provided by microperforations 41 in microperforation patterns 43, 45, and 47. Microperforation pattern 43 is located centrally on the top of the tray whereas microperforation patterns 45 and 47 are located on either side of the tray 19.

While the method according to the invention is not limited to any particular size of tray 17, it is, for example, suitable for trays for ground beef and other products commonly in use, which trays measure approximately 10 inches by 6 inches overall and are approximately 1.5 inches deep. A suitable wrap film segment 13 for use with such trays may be approximately 18 inches by 16 inches.

Perforation pattern 43 has the function of allowing moderately fast removal of air and replacement by inert gases and moderately fast permeation of ambient air. Numerous specific pattern configurations can accomplish this purpose. By way of example, perforations in the configuration described above constitute holes of approximately 0.01 diameter in a pattern measuring about 9.5 inches by 5.75 inches. The microperforations may be spaced in rows in about 8 rows of perforations having about 52 perforations per row with the perforated area being approximately 9.5 inches by 5.75 inches.

In another example, the method may be employed with a tray having dimensions of about 8.13 inches by about 5.5 inches with a depth of about 1.25 inches. In this configuration, the wrap film segment may be approximately 15 inches by 11.5 inches and a pattern of 8 rows of perforations each with 32 microperforations in an area approximately 6.88 inches by 4.5 inches. In both of these examples, it is a preferred option to have at least one microperforation pattern 45 consisting of a single row of perforations positioned on film wrap segments 13 so that it will reside on the side of overwrapped trays 19 as shown in FIGS. 3 and 4.

The microperforated wrap film 11 may be produced by different methods which do not form a part of this invention, as will be understood by those skilled in the art regarding permeable plastic film and also by reference to the above-noted U.S. patents. Reference is also made to U.S. Pat. No. 4,490,203 to Bose issued Dec. 25, 1984 describing methods for providing microperforations for micro porous plastic sheet material by use of a pulsing beam generated by a laser.

As schematically illustrated in FIG. 1, the completed overwrap product tray 19 is transported to a tray container packing unit wherein the multiplicity of the overwrap trays 19 are placed within a container 21 which may take the form of a bag of flexible plastic or may in other cases comprise a rigid or semi-rigid carton.

FIG. 1 illustrates a pack 19 containing comminuted meat 18, such as ground beef and the like. However, it is understood that meats other than those comminuted, like roasts, steaks, fresh ham, smoked ham, and the like which are subject to deterioration by excessive quantities of oxygen, can also comprise meat 18. Package 33 comprises two basic parts, namely a plurality of individual smaller packs 19 contained within a master shipping and storage container 31.

The materials of both the container 33 and the pack 19 may be formed of relatively high shrink film. The film forming container 33 can, for example, comprise an oriented film of an interpolymer composed of at least 70 weight percent interpolymerized vinylidene chloride with the remainder of at least one monoethylenically unsaturated comonomer, the film exhibiting at least 30 percent shrinkage at 100° C. The comonomer could be vinyl chloride or arcylonitrile, for example. The film of container 33 might also comprise other highly shrinkable films such as a highly oriented low plasticized polyvinyl chloride film, or laminates or multilayer structures including such films. The film comprising packs 19 can, for example, comprise a highly irradiated film comprised of homopolymers or copolymers of olefins like ethylene, such as taught by U.S. Pats. Nos. 2,877,500, 3,022,543, and 3,245,407, which films exhibit at least 30 percent shrinkage at 100° C. Other films of like characteristics, such as a highly plasticized polyvinylchloride film, might also be employed as well as laminates or multilayered structures including such films.

The film employed in forming container 33 should also be effective (the total effect of all layers or plies if more than one) to keep the gas transmission rate of oxygen therethrough down in the range of from about 1 to 20 cc./100 square inches/24 hours/atmosphere (preferably less than 3 cc. or less), as measured in accordance with test method ASTM D1434-58, the thickness of the film notwithstanding. Such high barrier shrink films can be those formed from such resins as the polyamides, polyesters, polyimides, acrylonitriles, polyvinylchlorides, polyvinylchloride/vinylidene chlorides and certain rubber hydrochlorides like Goodyear Tire and Rubber Company's Pliofilm N-1. Also several laminated, coextruded and/or other combination of films, or films and other materials, can provide high barrier characteristics, such as taught in U.S. Pat. No. Re. 24,992 and mentioned in French Pat. No. 1,484,153, for example, also to the extent such also exhibit the necessary high shrink capabilities.

The environment within the packing unit 23 is substantially exhausted of air through a port 25 and subsequently a modified atmosphere of inert gas such as nitrogen and/or carbon dioxide is provided through port 27, all of which is done while container 21 is unsealed. After the container 21 atmosphere (and preferably the tray 19 atmospheres) is replaced by the modified atmosphere present in the packing unit 23, the container 21 is sealed in any suitable fashion such as by forming a heat seal 31 with a heat sealer 29. The heat sealer 29 can be of any suitable known form including ultrasonic sealers, electrically-heated sealers, or other known types. Other forms of sealing may be employed such as by liquid adhesives, pressure-sensitive adhesives, or the like. The finished product container 33 is removed from the packing unit 23 for transportation and storage, at which time the packing unit 23 is available to receive another group of trays 19 into another empty container 21.

It should be understood that while the method of the invention is described in defined steps, one of such steps could be carried out in two stages or two steps could be combined as one in executing the method of the invention.

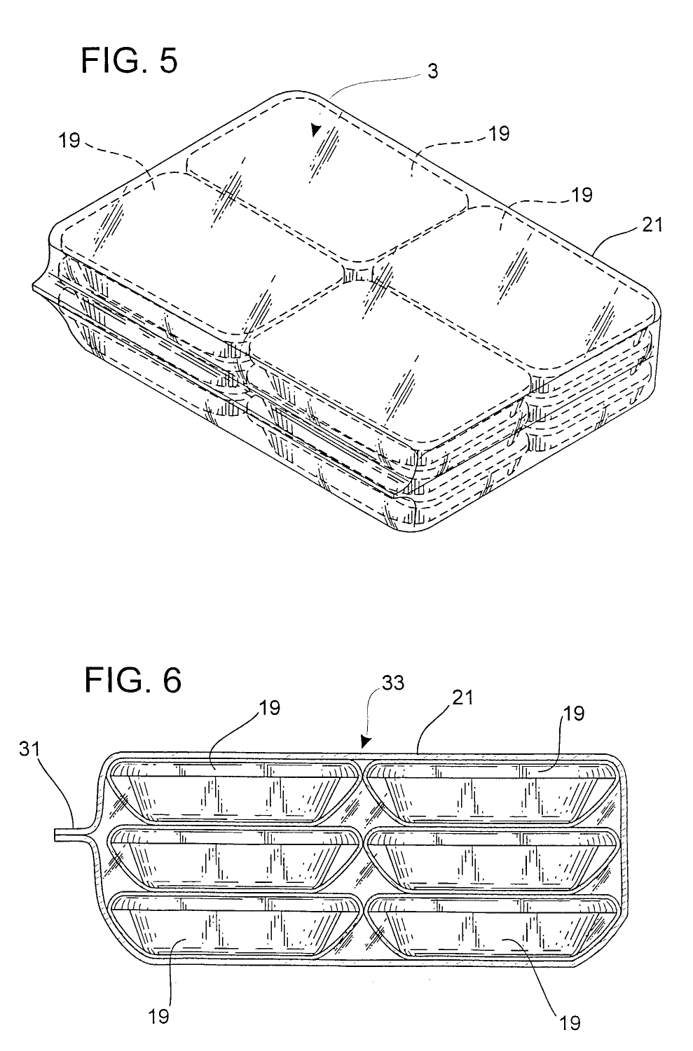

An example of completed product container 33 is shown in FIGS. 5 and 6. The product container 33 contains twelve overwrap product containing trays 19 which are packed in a 2×2×3 high configuration. If desired, the container 33 may be formed of thermally-shrinkable material and the packing unit 23 or other means may be employed to shrink the material of the product container 33 after it has been sealed at 31. The product container 33 may take a form other than the bag form of container 21 with the requirement being only that it be sealed air tight and formed of gas impermeable material to prevent the entrance of oxygen into the container 33 and the trays 19 during transport and storage. For example, the product container 33 could be formed in whole or in part by plasticized paperboard or other semi-rigid material. The material of the bag form of container 21 or other product container may be partially transparent permitting observation of the contents without opening the container, but this is not an essential feature of the method according to the invention.

It will be seen from the foregoing description and explanation that a method for producing modified environment packaging for food products wherein the storage containers for food trays produced by the method are especially effective in gaining access to the product of normal oxygen containing atmosphere during transportation and storage so that the product, especially ground beef product, has a safe, non-deteriorating storage life longer than achievable by previous methods. At the same time, the individual trays in the tray container are attractively packaged in a familiar form of package not subject to liquid spillage but adapted to rapidly permeate with oxygen containing atmosphere causing the fresh meat product to bloom to its bright red color which is desirable to the purchasers. Notwithstanding these advantages, the method can be carried out with readily available automatic packaging equipment with little or no modification thereof The method according to the invention can also be applied to fresh meats other than beef, to fresh fruits, and to vegetables (for example, mushrooms).

In addition to the variations and modifications to the invention which have been suggested or described above, it will be apparent to those skilled in the art that other modifications and variations to the invention are possible, and accordingly the scope of the invention is not to be considered limited to those variations suggested or described but is rather to be determined by reference to the appended claims.

What is claimed is:

1. The method of producing modified environment packaging for food products comprising the steps of:
A. providing a film supply of continuous plastic wrap film with repeating printed patterns and predetermined microperforations patterns;
B. providing a supply of food trays of predetermined shape to accommodate said food products;
C. feeding said trays to a product filling station and thence to a tray wrapping station;
D. separating a segment of said plastic wrap film having a complete one of said microperforations patterns for availability at said wrapping station;
E. at least partially wrapping each respective tray at said wrapping station with a segment of said plastic wrap film causing said microperforations of said microperforations pattern to be present on wrapping the top of the tray;
F. causing each said tray to be sealed at a sealing station;
G. transporting said trays to a package assembly station to be packed into impermeable tray containers in groups of from four to sixteen trays;
H. placing the trays of one said groups into an unsealed tray container;
I. at least partially exhausting air from said tray container and the wrapped trays therein and replacing the air from said tray container with a modified atmosphere composed primarily of inert gas;
J. sealing said tray container and transporting it to a tray container collection position;
whereby containers of food trays are produced with a long-period food-preserving modified atmosphere which containers may be opened to remove wrapped trays which will attain the desirable appearance caused by exposure to oxygen in the normal atmosphere ready for customer display.

2. The method as recited in claim 1 wherein said plastic wrap film is shrink film.

3. The method as recited in claim 1 wherein said plastic wrap film is stretch film.

4. The method as recited in claim 1 wherein the microperforations in said wrap film are small enough to retain liquids of the viscosity of water inside said wrapped trays.

5. The method of producing modified environment packaging for food products comprising the steps of:
A. providing a film supply of continuous plastic wrap film with repeating printed patterns and having predetermined microperforations patterns in registration with said printed patterns;
B. providing a supply of food trays of predetermined shape to accommodate said food products;
C. feeding said trays to a product filling station and thence to a tray wrapping station;
D. separating a segment of said plastic wrap film having a complete one of said printed patterns and a complete one of said microperforations patterns for availability at said wrapping station;
E. at least partially wrapping a respective tray at said wrapping station with a segment of said plastic wrap film to place a printed pattern on desired visible positions on said respective tray while causing said microperforations of said microperforations pattern to be present on said plastic wrap film at the center of the top of the tray wrapping and at one side of said tray wrapping with said microperforations being absent from some other portions of said plastic wrap film wrapped;
F. causing said tray to be heat sealed at a sealing station;
G. repeating steps D through F;
H. transporting said trays to a package assembly station to be packed into open ended impermeable flexible plastic tray containers in groups of from four to sixteen trays;
I. placing the trays of one said groups into an unsealed tray container;
J. at least partially exhausting air from said tray container and the wrapped trays therein and replacing the air from said tray container with a modified atmosphere composed primarily of inert gas;
K. sealing the open end of said tray container and transporting it to a tray container collection position;
L. repeating steps G through K;
whereby containers of food trays are produced with a long-period food-preserving modified atmosphere which containers may be opened to remove wrapped printed trays which will quickly attain the desired appearance caused by exposure to oxygen in the normal atmosphere ready for customer display.

6. The method as recited in claim 5 wherein said plastic wrap film is shrink film.

7. The method as recited in claim 5 wherein said plastic wrap film is stretch film.

8. The method as recited in claim 5 wherein the microperforations in said wrap film are small enough to retain liquids of the viscosity of water inside said wrapped trays.

9. The method as recited in claim 5 wherein said microperforation patterns include lines of perforations to be positioned on each of two sides of each wrapped tray.

10. The method of producing modified environment packaging for food products comprising the steps of:
A. providing a film supply of continuous shrink wrap or stretch wrap type of wrap film with repeated printed patterns and having predetermined microperforations patterns in registration with said printed patterns, said microperforations being small enough to prevent gravity flow of liquids with viscosity of water therethrough;
B. providing a supply of open-top plastic food trays of predetermined shape to accommodate said food products;
C. feeding said trays to a product filling station, placing product therein, and thence feeding said trays to a tray wrapping station;
D. separating a segment of said wrap film having a complete one of said printed patterns and a complete one of said microperforations patterns for availability at said wrapping station;
E. at least partially wrapping a respective tray at said wrapping station with a segment of said wrap film to place a printed pattern on desired visible positions on said respective tray while causing said microperforations of said microperforations pattern to be present on the center of the top of the tray wrap film and at least one side of the tray wrap film with said microperforations being absent from those portions of said tray wrapping subject to a greater degree of stretching;
F. causing said wrap film to be heat sealed to enclose said tray at a sealing station;
G. transporting said trays to a package assembly station to be packed into impermeable flexible plastic tray containers in groups of from four to sixteen trays;
H. placing the trays of one said groups into an unsealed tray container;
I. at least partially exhausting air from said tray container and replacing the air from said tray container with a modified atmosphere composed primarily of inert gas;
J. sealing said tray container and transporting it to a tray container collection position;
K. repeating steps D through K;
whereby containers of food trays are produced with a long-period food-preserving modified atmosphere which containers may be opened to remove wrapped printed trays which will quickly attain the desired appearance caused by exposure to oxygen in the normal atmosphere ready for customer display.

11. The method as recited in claim 10 wherein said inert gas comprises nitrogen.

12. The method as recited in claim 10 wherein said inert gas comprises carbon dioxide.

13. The method as recited in claim 10 wherein said microperforation patterns include a line of perforations on each of two sides of each wrapped tray.

14. The method as recited in claim 10 wherein said plastic wrap film is shrink film.

15. The method as recited in claim 10 wherein said plastic wrap film is stretch film.
